(19) United States
(12) Patent Application Publication
(10) Pub. No.: US 2023/0073273 A1
(43) Pub. Date: Mar. 9, 2023

(54) RUBBER COMPOSITION, METHOD FOR PREPARING SAME, AND TIRE FOR CONSTRUCTION VEHICLE

(71) Applicant: The Yokohama Rubber Co., LTD., Tokyo (JP)

(72) Inventor: Kento TAKAHASHI, Kanagawa (JP)

(21) Appl. No.: 17/757,856

(22) PCT Filed: Dec. 24, 2020
(86) PCT No.: PCT/JP2020/048523

§ 371 Date: Jun. 22, 2022

(30) Foreign Application Priority Data
Dec. 27, 2019 (JP) 2019-237892
Nov. 10, 2020 (JP) 2020-186956

(51) Int. Cl. C08K 5/30; C08K 3/04; C08K 3/22; B60C 1/00

(52) U.S. Cl. CPC C08K 5/30; C08K 3/04; C08K 3/22; B60C 1/0016; C08K 2003/2296

(57) ABSTRACT

A rubber composition is prepared by mixing a specific hydrazide compound at a ratio of 0.5 to 3.0 parts by mass, zinc oxide at a ratio of 1 to 5 parts by mass, and carbon black having N₂SA of 60 to 150 m²/g at a ratio of 30 to 60 parts by mass per 100 parts by mass of diene rubber containing 80 parts by mass or more of natural rubber. The rubber composition is prepared through (a) mixing the hydrazide compound and the carbon black to obtain a mixture, and (b) mixing the zinc oxide with the mixture obtained in step (a) to obtain a mixture. A maximum ultimate temperature during the mixture in step (a) is from 140 to 170° C. A storage modulus and elongation at break have a specific relationship.

### TECHNICAL FIELD

The present technology relates to a rubber composition, a method for preparing the same, and a tire for a construction vehicle, and in detail, relates to a rubber composition having excellent low heat build-up without impairing durability, a method for preparing the same, and a tire for a construction vehicle.

### BACKGROUND ART

Construction vehicles, such as large dump trucks that operate at quarries and/or construction sites, operate for a long time while carrying a heavy load. Large tires mounted on such a construction vehicle are required to suppress heat build-up to suppress an overheat state of the tire. On the other hand, in recent years, the increase in the size of the tire has progressed to improve transport efficiency, and there is a demand for low heat build-up more and more.

Typically, in order to obtain low heat build-up, there is a method of reducing a blended amount of carbon black, but this decreases storage modulus (E′) and increases a strain of a rubber, possibly causing a tire failure.

In this way, the low heat build-up and the durability of large tires are in a trade-off relationship.

Japan Patent No. 4541475 discloses a method of manufacturing a rubber component. The method simultaneously feeds 0.1 to 5 parts by weight of a hydrazide compound and 0.2 to 5 parts by weight of zinc oxide per 100 parts by weight of a rubber compound consisting of at least one kind selected from natural rubber and diene synthetic rubber and carbon black in a rubber kneading step before feeding a vulcanizing agent and kneads it at a maximum temperature of from 130° C. to 170° C.

However, the technique disclosed in Japan Patent No. 4541475 cannot satisfy low heat build-up required in association with the increase in the size of the tire without impairing the durability of the tire.

### SUMMARY

The present technology provides a rubber composition excellent in low heat build-up without impairing durability, a method for preparing the same, and a tire for a construction vehicle.

As a result of diligent research, the present inventors have blended, to diene rubber having a specific composition, particular amounts of specific hydrazide compound, zinc oxide, and carbon black, and further determined a mixing condition of the hydrazide compound, the zinc oxide, and the carbon black.

An embodiment of the present technology provides a rubber composition prepared by mixing a hydrazide compound represented by the following Formula (1) at a ratio of 0.5 to 3.0 parts by mass, zinc oxide at a ratio of 1 to 5 parts by mass, and carbon black having a nitrogen adsorption specific surface area (N₂SA) of 60 to 150 m²/g at a ratio of 30 to 60 parts by mass per 100 parts by mass of diene rubber containing 80 parts by mass or more of natural rubber and/or synthetic isoprene rubber. The rubber composition is prepared through (a) mixing at least the hydrazide compound and the carbon black to obtain a mixture, and (b) mixing the zinc oxide with the mixture obtained in step (a) to obtain a mixture. A maximum ultimate temperature during the mixture in step (a) is from 140 to 170° C. The composition has a physical property of the following Formula (2).

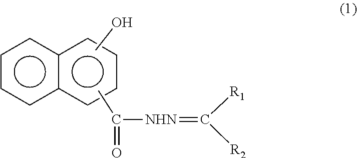

(In the Formula (1), each of R₁ and R₂ independently represents an alkyl group having 1 to 18 carbons).

1500≤{Storage modulus at 20° C. (E′)×elongation at break (EB)}≤6000 (2)

An embodiment of the present technology provides a method for preparing a rubber composition that mixes a hydrazide compound represented by the following Formula (1) at a ratio of 0.5 to 3.0 parts by mass, zinc oxide at a ratio of 1 to 5 parts by mass, and carbon black having a nitrogen adsorption specific surface area (N₂SA) of 60 to 150 m²/g at a ratio of 30 to 60 parts by mass per 100 parts by mass of diene rubber containing 80 parts by mass or more of natural rubber and/or synthetic isoprene rubber. The rubber composition is prepared through (a) mixing at least the hydrazide compound and the carbon black to obtain a mixture, and (b) mixing the zinc oxide with the mixture obtained in step (a) to obtain a mixture. A maximum ultimate temperature during the mixture in step (a) is from 140 to 170° C. The composition has a physical property of the following Formula (1).

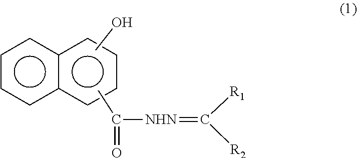

(In the Formula (1), each of R₁ and R₂ independently represents an alkyl group having 1 to 18 carbons).

1500≤{Storage modulus at 20° C. (E′)×elongation at break (EB)}≤6000 (2)

Furthermore, an embodiment of the present technology provides a tire for a construction vehicle in which the rubber composition according to an embodiment of the present technology is used in an undertread. The rubber composition according to an embodiment of the present technology is prepared by mixing the hydrazide compound represented by the Formula (1) at the ratio of 0.5 to 3.0 parts by mass, the zinc oxide at the ratio of 1 to 5 parts by mass, and the carbon black having the nitrogen adsorption specific surface area (N₂SA) of 60 to 150 m²/g at the ratio of 30 to 60 parts by mass per 100 parts by mass of the diene rubber containing 80 parts by mass or more of the natural rubber and/or the synthetic isoprene rubber. The rubber composition is prepared through step (a) of mixing at least the hydrazide compound and the carbon black to obtain the mixture, and step (b) of mixing the zinc oxide with the mixture obtained in step (a) to obtain the mixture. The maximum ultimate temperature during the mixture in step (a) is from 140 to 170° C. The composition has the physical property of 1500≤{Storage modulus at 20° C. (E′)×elongation at break (EB)}≤6000. Therefore, the rubber composition has excellent low heat build-up without impairing durability.

Using the rubber composition according to an embodiment of the present technology especially in the undertread of the tire for the construction vehicle allows further reducing heat build-up of a large tire.

### DETAILED DESCRIPTION

The present technology will be described in further detail below.

### Diene Rubber

A required component of the diene rubber used in an embodiment of the present technology is natural rubber (NR) and/or synthetic isoprene rubber (IR). From the perspective of the effects of an embodiment of the present technology, when the entire diene rubber is 100 parts by mass, the blended amount of NR and/or IR is preferably 80 parts by mass or more. The diene rubber other than NR or IR can be used, and examples of the diene rubber can include styrene-butadiene copolymer rubber (SBR), butadiene rubber (BR), and acrylonitrile-butadiene copolymer rubber (NBR). Furthermore, the molecular weight and the microstructure of the diene rubber are not particularly limited. The diene rubber may be terminal-modified with, for example, an amine, amide, silyl, alkoxysilyl, carboxyl, or hydroxyl group or may be epoxidized.

### Hydrazide Compound

The hydrazide compound used in an embodiment of the present technology is represented by the following Formula (1).

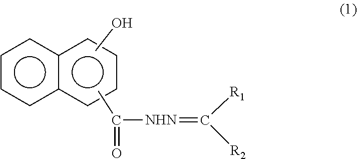

(In the Formula (1), each of R₁ and R₂ independently represents an alkyl group having 1 to 18 carbons).

Specifically, the examples include 1-hydroxy-N′-(1-methylethylidene)-2-naphthoic acid hydrazide, 1-hydroxy-N′-(1-methylpropylidene)-2-naphthoic acid hydrazide, 1-hydroxy-N′-(1-methylbutylidene)-2-naphthoic acid hydrazide, 1-hydroxy-N′-(1,3-dimethylbutylidene)-2-naphthoic acid hydrazide, 3 -hydroxy-N′-(1-methylethylidene)-2-naphthoic acid hydrazide, 3-hydroxy-N′-(1-methylpropylidene)-2-naphthoic acid hydrazide, 3-hydroxy-N′-(1-methylbutylidene)-2-naphthoic acid hydrazide, and 3-hydroxy-N′-(1,3-dimethylbutylidene)-2-naphthoic acid hydrazide. Among them, from the perspective of improvement in the effects of an embodiment of the present technology, the hydrazide compound represented the following Formula (10) is preferred.

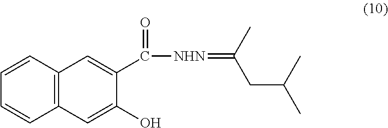

### Carbon Black

The carbon black used in an embodiment of the present technology is required to have a nitrogen adsorption specific surface area (N₂ SA) of from 60 to 150 m²/g. The nitrogen adsorption specific surface area (N₂SA) of less than 60 m²/g reduces durability. On the other hand, the nitrogen adsorption specific surface area (N₂SA) of greater than 150 m²/g deteriorates heat build-up. In an embodiment of the present technology, from the perspective of improving the effects of the present technology, the nitrogen adsorption specific surface area (N₂ SA) is preferably from 80 to 130 m²/g. The nitrogen adsorption specific surface area (N₂SA) is a value obtained in accordance with JIS K6217-2.

### Compounding Ratio of Rubber Composition

The rubber composition according to an embodiment of the present technology is prepared by mixing a hydrazide compound represented by the Formula (1) at a ratio of 0.5 to 3.0 parts by mass, zinc oxide at a ratio of 1 to 5 parts by mass, and carbon black having a nitrogen adsorption specific surface area (N₂SA) of 60 to 150 m²/g at a ratio of 30 to 60 parts by mass per 100 parts by mass of diene rubber.

The blended amount of the hydrazide compound of less than 0.5 parts by mass fails to achieve the effects of an embodiment of the present technology as the blended amount is too small. On the other hand, the blended amount of greater than 3.0 parts by mass deteriorates heat build-up.

The blended amount of the zinc oxide of less than 1 parts by mass deteriorates both of heat build-up and durability, and conversely, the blended amount of greater than 5 parts by mass deteriorates durability.

The blended amount of the carbon black of less than 30 parts by mass deteriorates durability. The blended amount of greater than 60 parts by mass deteriorates heat build-up and durability.

In the rubber composition of an embodiment of the present technology, the blended amount of the zinc oxide is preferably from 1 to 3 parts by mass per 100 parts by mass of the diene rubber.

In the rubber composition of an embodiment of the present technology, the blended amount of the carbon black is preferably from 35 to 50 parts by mass per 100 parts by mass of the diene rubber.

### Other Components

The rubber composition in an embodiment of the present technology can be blended with, in addition to the components described above, vulcanizing or crosslinking agents; vulcanizing or crosslinking accelerators; various fillers, such as silica, clay, talc, and calcium carbonate; anti-aging agents; plasticizers; resins; and various additives commonly blended in rubber compositions, such as curing agents. The additives are kneaded by a common method to obtain a composition that can then be used for vulcanization or crosslinking. Blended amounts of these additives may be any standard blended amount in the related art, so long as the object of the present technology is not hindered.

Note that when silica is blended, a blended amount thereof is preferably 30 parts by mass or less and more preferably from 5 to 25 parts by mass per 100 parts by mass of the diene rubber. The blended amount of the silica of greater than 30 parts by mass decreases the hardness of the rubber and a strain is likely to occur, possibly deteriorating durability.

The rubber composition according to an embodiment of the present technology has excellent low heat build-up without impairing durability, and thus can be suitably used in a tread of a tire for a construction vehicle, and especially an undertread configured at an inner side in a tire radial direction with respect to a cap tread. The tire for a construction vehicle according to an embodiment of the present technology is preferably a pneumatic tire that can be inflated with any gas including air and inert gas, such as nitrogen.

Use of the rubber composition according to an embodiment of the present technology for an undertread further enhances the effects of an embodiment of the present technology.

The rubber composition according to an embodiment of the present technology is prepared by mixing the hydrazide compound, the zinc oxide, and the carbon black under a specific mixing condition.

That is, the rubber composition according to an embodiment of the present technology is prepared through a first step of mixing at least the hydrazide compound and the carbon black to obtain a mixture, and a second step of mixing the zinc oxide with the mixture obtained in the first step to obtain a mixture. The maximum ultimate temperature during the mixture in the first step is from 140 to 170° C.

Through the studies by the present inventors, knowledge that the interaction of the hydrazide compound, the carbon black, and the diene rubber allows obtaining low heat build-up while suppressing the strain of the rubber has been obtained. However, assuming that the hydrazide compound, the carbon black, and the zinc oxide are mixed simultaneously, the zinc oxide reacts to the hydrazide compound first. This hinders the interaction, and the effects of an embodiment of the present technology cannot be achieved.

Therefore, in an embodiment of the present technology, as long as after mixture of the hydrazide compound and the carbon black, the zinc oxide may be fed/mixed at any timing before vulcanization.

For example, in the first step, the diene rubber, the hydrazide compound, the carbon black, and further another component (except for a vulcanization system described later) are mixed to obtain the mixture. The first step can be performed using a known mixer. The kneading time is, for example, from two to five minutes. Also, the maximum ultimate temperature during the mixture of the first step is from 140 to 170° C. The maximum ultimate temperature of less than 140° C. fails to improve heat build-up. On the other hand, the maximum ultimate temperature of greater than 170° C. deteriorates durability. The further preferred maximum ultimate temperature is from 145 to 160° C.

In this first step, the hydrazide compound, the carbon black, and the diene rubber interact with one another.

After the completion of the first step, the obtained mixture is released out of the mixer and cooled.

The cooled mixture can be fed again into the mixer for the purpose of reducing viscosity and rekneading can be performed (a remill step). In an embodiment of the present technology, the zinc oxide can be fed and mixed in the remill step as the second step.

On the other hand, after the completion of the first step or after the completion of the remill step, the vulcanization system (a vulcanizing or crosslinking agent or a vulcanizing or crosslinking accelerator) can be added to the obtained mixture and mixed (a final step). In an embodiment of the present technology, the zinc oxide can be fed and mixed in the final step as the second step.

The mixing conditions in the remill step are not particularly limited, but usually the mixing temperature is from 130 to 160° C., and the mixing time is from 1.5 to 4 minutes.

Note that, although the three mixing steps of the first step, the remill step, and the final step have been exemplified above, an embodiment of the present technology is not limited thereto. An additional mixing step can be performed, and as long as the condition of after mixing the hydrazide compound and the carbon black is met, the zinc oxide can be fed and mixed in any mixing step.

The rubber composition of an embodiment of the present technology has the property of the following Formula (2).

1500≤{Storage modulus at 20° C. (E′)×elongation at break (EB)}≤6000 (2)

When the Formula (2) is not satisfied, it is not possible to achieve the effects of an embodiment of the present technology in which the rubber composition having excellent low heat build-up is obtained without impairing durability. The physical property of Formula (2) is achieved by adjusting the blended amounts of the hydrazide compound, the carbon black, and sulfur.

In an embodiment of the present technology, it is more preferable that the Formula (2) satisfies the following Formula (20).

1700≤{Storage modulus at 20° C. (E′)×elongation at break (EB)}≤5000 (20)

Not that the storage modulus (E′) is a value (MPa) measured in accordance with JIS (Japanese Industrial Standard) K6394 using a viscoelasticity spectrometer under conditions of initial strain of 10%, amplitude of ±2%, a frequency of 20 Hz, and 20° C.

The elongation at break (EB) is measured at room temperature in accordance with JIS K6251 (MPa).

The rubber composition according to an embodiment of the present technology can be used to manufacture a pneumatic tire according to a conventional method of manufacturing pneumatic tires.

### Example

The present technology will be described in further detail by way of examples and comparative examples, but the present technology is not limited by these examples.

### Standard Example, Examples 1 to 5, and Comparative Examples 1 to 10

### Preparation of Sample

In the compounding proportions (parts by mass) and the step order shown in Table 1, using a 1.7-liter sealed Banbury mixer, the respective components shown in Table 1 were mixed for 4 minutes, and the obtained mixture was released out of the mixer at the time that the maximum ultimate temperature shown in Table 1 was reached (the first step).

After the completion of the first step, the remill step was performed or not performed, and a vulcanization system was added to the obtained mixture and mixed (the final step). In the case where the remill step was performed, the mixing temperature was 150° C. and the mixing time was three minutes.

Next, the obtained rubber composition was pressure vulcanized in a predetermined mold at 160° C. for 20 minutes to obtain a vulcanized rubber test piece, and then the test methods shown below were used to measure the physical properties of the rubber.

(E′)×(EB): calculated by the method described above.

tan δ(60° C.): The tan δ(60° C.) was measured under conditions of elongation deformation strain of 10±2%, a vibration frequency of 20 Hz, and a temperature of 60° C., using a viscoelastic spectrometer (available from Toyo Seiki Seisaku-sho, Ltd.) in accordance with JIS K 6394: 2007. The results were expressed as index values with Standard Example being assigned the value of 100. Larger index values indicate lower heat build-up.

Tire heat build-up: The heat build-up was evaluated in an actual vehicle test. A test tire of tire size 46/90R57 was assembled on a specified rim of the TRA (The Tire and Rim Association, Inc.) standard, and a reference air pressure and a load of the TRA standard were applied. Further, the test tires were mounted on all wheels of a construction vehicle that was a test vehicle. In the evaluation for heat build-up, the temperature of the tire inner surface of the tread portion before and after the test vehicle travels for 60 minutes at a traveling speed of 10 km/h was measured. Then, the measurement results were expressed as index values and evaluated with Standard Example being assigned as the reference (100). In this evaluation, larger values indicate the smaller increase in the temperature of the tread portion, which means low heat build-up. Note that the vulcanized rubbertest piece manufactured in each example was used in the undertread of the test tire.

Tire durability: Durability was evaluated in a drum test. A test tire of tire size 46/90R57 was assembled on a specified rim of the TRA standard, and a reference air pressure of the TRA standard was applied. In the evaluation for durability, the test tire traveled at the traveling speed of 10 km/h, drum traveling was performed for 200 hours at the load 120% of the TRA standard, and the appearance of the undertread after disassembly was evaluated. The evaluation references are as follows. Note that the vulcanized rubber test piece manufactured in each example was used in the undertread of the test tire.

Good: Without a crack at the inside of the undertread or an interface with a peripherally located member, which is good

Fair: The maximum crack length at the inside of the undertread or the interface with the peripherally located member is less than 5 mm, which is slightly poor.

Poor: The maximum crack length at the inside of the undertread or the interface with the peripherally located member is 5 mm or more, which is poor.

The results are shown in Table 1.

[Table 1-1]

| | Standard | Comparative | Comparative | Example |
|---|---|---|---|---|
| | Example | Example 1 | Example 2 | 1 |
| First step | | | | |
| NR *1 | 100 | 100 | 100 | 100 |
| Carbon black ISAF *2 | 40 | 40 | 40 | 40 |
| Carbon black FEF *3 | — | — | — | — |
| Silica *4 | — | — | — | — |
| Hydrazide compound 1 *5 | — | 1.0 | 1.0 | 1.0 |
| Hydrazide compound 2 *6 | | | | |
| Hydrazide compound 3 *7 | | | | |
| Hydrazide compound 4 *8 | | | | |
| Hydrazide compound 5 *9 | | | | |
| Stearic acid *10 | 2.0 | 2.0 | 2.0 | 2.0 |
| Anti-aging agent 6C *11 | 2.0 | 2.0 | 2.0 | 2.0 |
| Anti-aging agent RD *12 | 1.0 | 1.0 | 1.0 | 1.0 |
| Zinc oxide *13 | 3.0 | 3.0 | 2.0 | — |
| Maximum ultimate temperature | 150 | 150 | 150 | 150 |
| Remill step | | | | |
| Zinc oxide *13 | — | — | — | 3.0 |
| Final step | | | | |
| Zinc oxide *13 | — | — | 1.0 | — |
| Vulcanization accelerator *14 | 1.5 | 1.5 | 1.5 | 1.5 |
| Sulfur *15 | 2.0 | 2.0 | 2.0 | 2.0 |
| Measurement result | | | | |
| (E’) × (EB) | 2500 | 2498 | 2498 | 2554 |
| tan δ (60° C.) | 100 | 99 | 99 | 103 |
| | 100 | 100 | 100 | 104 |
| Fire durability | Good | Good | Good | Good |

[Table 1-2]

| | Example | Example | Example | Comparative |
|---|---|---|---|---|
| | 2 | 3 | 4 | Example 3 |
| First step | | | | |
| NR *1 | 100 | 100 | 100 | 100 |
| Carbon black ISAF *2 | 40 | 40 | 40 | 40 |
| Carbon black FEF *3 | — | — | — | — |
| Silica *4 | — | — | — | — |
| Hydrazide compound 1 *5 | 1.0 | | | |
| Hydrazide compound 2 *6 | | 1.0 | | |
| Hydrazide compound 3 *7 | | | 1.0 | |
| Hydrazide compound 4 *8 | | | | 1.0 |
| Hydrazide compound 5 *9 | | | | |
| Stearic acid *10 | 2.0 | 2.0 | 2.0 | 2.0 |
| Anti-aging agent 6C *11 | 2.0 | 2.0 | 2.0 | 2.0 |
| Anti-aging agent RD *12 | 1.0 | 1.0 | 1.0 | 1.0 |
| Zinc oxide *13 | — | — | — | — |
| Maximum ultimate temperature | 150 | 150 | 150 | 150 |
| Remill step | | | | |
| Zinc oxide *13 | — | — | — | — |
| Final step | | | | |
| Zinc oxide *13 | 3.0 | 3.0 | 3.0 | 3.0 |
| Vulcanization accelerator *14 | 1.5 | 1.5 | 1.5 | 1.5 |
| Sulfur *15 | 2.0 | 2.0 | 2.0 | 2.0 |
| Measurement result | | | | |
| (E’) × (EB) | 2532 | 2405 | 2380 | 2026 |
| tan δ (60° C.) | 106 | 103 | 103 | 95 |
| | 107 | 103 | 103 | 96 |
| Tire durability | Good | Good | Good | Good |

[Table 1-3]

| | Comparative | Comparative | Comparative | Comparative |
|---|---|---|---|---|
| | Example 4 | Example 5 | Example 6 | Example 7 |
| First step | | | | |
| NR *1 | 100 | 100 | 100 | 100 |
| Carbon black ISAF *2 | 40 | 25 | 65 | 40 |
| Carbon black FEF *3 | — | — | — | — |
| Silica *4 | — | — | — | — |
| Hydrazide compound 1 *5 | | 1.0 | 1.0 | 3.5 |
| Hydrazide compound 2 *6 | | | | |
| Hydrazide compound 3 *7 | | | | |
| Hydrazide compound 4 *8 | | | | |
| Hydrazide compound 5 *9 | 1.0 | | | |
| Stearic acid *10 | 2.0 | 2.0 | 2.0 | 2.0 |
| Anti-aging agent 6C *11 | 2.0 | 2.0 | 2.0 | 2.0 |
| Anti-aging agent RD *12 | 1.0 | 1.0 | 1.0 | 1.0 |
| Zinc oxide *13 | — | — | — | — |
| Maximum ultimate temperature | 150 | 150 | 150 | 150 |
| Remill step | | | | |
| Zinc oxide *13 | — | — | — | — |
| Final step | | | | |
| Zinc oxide *13 | 3.0 | 3.0 | 3.0 | 3.0 |
| Vulcanization accelerator *14 | 1.5 | 1.5 | 1.5 | 1.5 |
| Sulfur *15 | 2.0 | 2.0 | 2.0 | 2.0 |
| Measurement result | | | | |
| (E’) × (EB) | 1899 | 1280 | 6089 | 2015 |
| tan δ (60° C.) | 96 | 109 | 94 | 97 |
| | 97 | 108 | 95 | 96 |
| Tire durability | Good | Fair | Fair | Good |
| [Table 1-4] | | | | |
| | Comparative | Example | Comparative | Comparative |
| | Example 8 | 5 | Example 9 | Example 10 |
| First step | | | | |
| NR *1 | 100 | 100 | 100 | 100 |
| Carbon black ISAF *2 | 40 | 36 | — | 40 |
| Carbon black FEF *3 | — | — | 40 | — |
| Silica *4 | — | 10 | — | — |
| Hydrazide compound 1 *5 | 0.3 | 1.0 | 1.0 | 1.0 |
| Hydrazide compound 2 *6 | | | | |
| Hydrazide compound 3 *7 | | | | |
| Hydrazide compound 4 *8 | | | | |
| Hydrazide compound 5 *9 | | | | |
| Stearic acid *10 | 2.0 | 2.0 | 2.0 | 2.0 |
| Anti-aging agent 6C *11 | 2.0 | 2.0 | 2.0 | 2.0 |
| Anti-aging agent RD *12 | 1.0 | 1.0 | 1.0 | 1.0 |
| Zinc oxide *13 | — | — | — | — |
| Maximum ultimate temperature | 150 | 150 | 150 | 130 |
| Remill step | | | | |
| Zinc oxide *13 | — | — | — | 3.0 |
| Final step | | | | |
| Zinc oxide *13 | 3.0 | 3.0 | 3.0 | — |
| Vulcanization accelerator *14 | 1.5 | 1.5 | 1.5 | 1.5 |
| Sulfur *15 | 2.0 | 2.0 | 2.0 | 2.0 |
| Measurement result | | | | |
| (E’) × (EB) | 2005 | 2046 | 1480 | 2724 |
| tan δ (60° C.) | 100 | 107 | 108 | 100 |
| | 100 | 109 | 108 | 100 |
| Tire durability | Good | Good | Fair | Good |

*1: NR (RSS#3)
*2: Carbon black ISAF (available from Nittetsu Carbon Co., Ltd., product name Niteron #300, N₂SA = 120 m²/g)
*3: Carbon black FEF (available from Tokai Carbon Co., Ltd., product name SEAST SO, N₂SA = 42 m²/g)
*4: Silica (available from EVONIK, product name ULTRASIL VN3GR)
*5: Hydrazide compound 1 (DC-01, available from Otsuka Chemical Co., Ltd., ahydrazide compound represented by the following Formula 10)
*6: Hydrazide compound 2 (a hydrazide compound represented by the following formula) 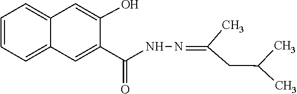 [SMILES: CC(CC(C)C)=NNC(=O)c1cc2ccccc2cc1O]
*7: Hydrazide compound 3 (a hydrazide compound represented by the following formula) 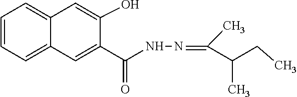 [SMILES: CCC(C)C(C)=NNC(=O)c1cc2ccccc2cc1O]
*8: Hydrazide compound 4 (adipic acid dihydrazide, adipic acid dihydrazide (ADH), available from Otsuka Chemical Co., Ltd.)
*9: Hydrazide compound 5 (sebacic acid dihydrazide, sebacic acid dihydrazide (SDH), available from Otsuka Chemical Co., Ltd.)
*10: Stearic acid (Beads Stearic Acid YR, available from NOF Corporation)
*11: Anti-aging agent 6C (Santoflex 6PPD, available from Flexsys)
*12: Anti-aging agent RD (Nocrac 224, available from Ouchi Shinko Chemical Industrial Co., Ltd.)
*13: Zinc oxide (Zinc Oxide III, available from Seido Chemical Industry Co., Ltd.)
*14: Vulcanization accelerator (NOCCELER NS, available from Ouchi Shinko Chemical Industrial Co., Ltd.)
*15: Sulfur (Golden Flower oil treated sulfur powder, available from Tsurumi Chemical Industry Co., Ltd.)

Method of manufacturing hydrazide compound 2:

3-Hydroxy-2-naphthoic acid hydrazide and 3 -methyl-2-pentanone were stirred while warmed. After concentrating and cooling the reaction solution, precipitated crystals were filtered and dried under reduced pressure to obtain the hydrazide compound 2 having the structure represented by the formula described above.

Method of manufacturing hydrazide compound 3:

3-Hydroxy-2-naphthoic acid hydrazide and 3 -pentanone were stirred while warmed. After concentrating and cooling the reaction solution, precipitated crystals were filtered and dried under reduced pressure to obtain the hydrazide compound 3 having the structure represented by the formula described above.

From the results of Table 1, the rubber compositions of Examples 1 to 5 were prepared by mixing the hydrazide compound represented by the Formula (1) at a ratio of 0.5 to 3.0 parts by mass, the zinc oxide at a ratio of 1 to 5 parts by mass, and the carbon black having a nitrogen adsorption specific surface area (N₂SA) of 60 to 150 m²/g at a ratio of 30 to 60 parts by mass per 100 parts by mass of the diene rubber containing 80 parts by mass or more of natural rubber and/or synthetic isoprene rubber. The rubber compositions were prepared through the first step of mixing at least the hydrazide compound and the carbon black to obtain a mixture, and the second step of mixing the zinc oxide with the mixture obtained in the first step to obtain a mixture. The maximum ultimate temperature during the mixture in the first step is from 140 to 170° C. The composition has the property of 1500≤{Storage modulus at 20° C. (E′)×elongation at break (EB)}≤6000. Therefore, compared with the rubber composition of Standard Example, the rubber compositions of Examples 1 to 5 have excellent low heat build-up without impairing durability.

On the other hand, in Comparative Example 1, since the hydrazide compound, the carbon black, and the zinc oxide were mixed simultaneously in the first step, the result was substantially similar to that of Standard Example.

In Comparative Example 2, although a portion of the zinc oxide was mixed in the final step, since the hydrazide compound, the carbon black, and the zinc oxide were mixed simultaneously in the first step, the result was substantially similar to Standard Example.

In Comparative Example 3, the hydrazide compound represented by Formula (10) was not blended and the adipic acid dihydrazide was blended instead, and thus low heat build-up was deteriorated.

In Comparative Example 4, the hydrazide compound represented by Formula (10) was not blended and the sebacic acid dihydrazide was blended instead, and thus low heat build-up was deteriorated.

In Comparative Example 5, since the blended amount of the carbon black was less than the lower limit specified in an embodiment of the present technology, durability was deteriorated.

In Comparative Example 6, since the blended amount of the carbon black exceeded the upper limit specified in an embodiment of the present technology, heat build-up and durability were deteriorated.

In Comparative Example 7, since the blended amount of the hydrazide compound exceeded the upper limit specified in an embodiment of the present technology, heat build-up was deteriorated.

In Comparative Example 8, since the blended amount of the hydrazide compound was less than the lower limit specified in an embodiment of the present technology, the result was substantially similar to that of Standard Example.

In Comparative Example 9, the nitrogen adsorption specific surface area (N₂ SA) of the carbon black did not fall within the range specified in an embodiment of the present technology, and thus durability was deteriorated.

In Comparative Example 10, since the maximum ultimate temperature in the first step was less than the lower limit specified in an embodiment of the present technology, the result was substantially similar to that of Standard Example.

1. A rubber composition prepared by mixing a hydrazide compound represented by the following Formula (1) at a ratio of 0.5 to 3.0 parts by mass, zinc oxide at a ratio of 1 to 5 parts by mass, and carbon black having a nitrogen adsorption specific surface area (N₂SA) of 60 to 150 m²/g at a ratio of 30 to 60 parts by mass per 100 parts by mass of diene rubber containing 80 parts by mass or more of natural rubber and/or synthetic isoprene rubber, the rubber composition being prepared through (a) mixing at least the hydrazide compound and the carbon black to obtain a mixture, and (b) mixing the zinc oxide with the mixture obtained in step (a) to obtain a mixture,
a maximum ultimate temperature during the mixture in step (a) being from 140 to 170° C., and
the composition having a physical property of the following Formula (1) 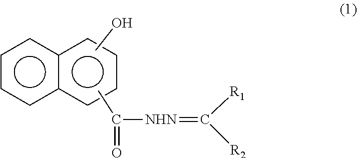
in the Formula (1), each of R₁ and R₂ independently represents an alkyl group having 1 to 18 carbons,
1500≤{Storage modulus at 20° C. (F)×elongation at break (EB)}≤6000 (2).

2. The rubber composition according to claim 1, wherein the Formula (2) satisfies the following Formula (20),
1700≤{Storage modulus at 20° C. (E)×elongation at break (EB)}≤5000 (20).

3. The rubber composition according to claim 1, wherein silica is contained at a ratio of 30 parts by mass or less.

4. The rubber composition according to claim 1, wherein the hydrazide compound represented by the Formula (1) is represented by the following Formula (10),

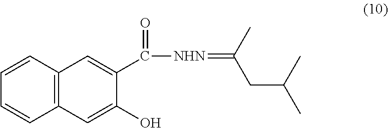

5. The rubber composition according to claim 1, wherein the carbon black has a nitrogen adsorption specific surface area (N₂SA) of from 80 to 130 m²/g.

6. The rubber composition according to claim 1, wherein the rubber composition is used in an undertread of a tire for a construction vehicle.

7. A method for preparing a rubber composition that mixes a hydrazide compound represented by the following Formula (1) at a ratio of 0.5 to 3.0 parts by mass, zinc oxide at a ratio of 1 to 5 parts by mass, and carbon black having a nitrogen adsorption specific surface area (N₂SA) of 60 to 150 m²/g at a ratio of 30 to 60 parts by mass per 100 parts by mass of diene rubber containing 80 parts by mass or more of natural rubber and/or synthetic isoprene rubber,
the rubber composition being prepared through (a) mixing at least the hydrazide compound and the carbon black to obtain a mixture, and (b) mixing the zinc oxide with the mixture obtained in step (a) to obtain a mixture,
a maximum ultimate temperature during the mixture in step (a) being from 140 to 170° C., and
the composition having a physical property of the following Formula (1) 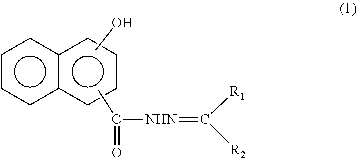
in the Formula (1), each of R₁ and R₂ independently represents an alkyl group having 1 to 18 carbons
1500≤{Storage modulus at 20° C. (F)×elongation at break (EB)}≤6000 (2).

8. The method for preparing the rubber composition according to claim 7, wherein the maximum ultimate temperature during the mixture in step (a) is from 145 to 160° C.

9. A tire for a construction vehicle, wherein the rubber composition according to claim 1 is used in an undertread.
